(19) United States
(12) Patent Application Publication
(10) Pub. No.: US 2024/0322740 A1
(43) Pub. Date: Sep. 26, 2024

(54) Safety Solar System for Fuel Station Canopy

(71) Applicants: John F. Scorsone, Philadelphia, PA (US); Robert M. Iorio, Upper Darby, PA (US)

(72) Inventors: John F. Scorsone, Philadelphia, PA (US); Robert M. Iorio, Upper Darby, PA (US)

(21) Appl. No.: 18/581,746

(22) Filed: Feb. 20, 2024

Related U.S. Application Data
(60) Provisional application No. 63/486,021, filed on Feb. 20, 2023.

(51) Int. Cl. H02S 20/23; H02S 30/10; H02S 40/32; H02S 40/34; H02S 40/36

(52) U.S. Cl. CPC H02S 20/23; H02S 30/10; H02S 40/32; H02S 40/34; H02S 40/36

(57) ABSTRACT

A safety solar system for a fuel station canopy. The present invention comprises safety features that allow the electrical junction points to be closer to solar panels, such as microinverters, combiner boxes, and fire-retardant clay. A plurality of solar panels can be wired to a microinverter, which is then wired to a combiner box to reduce the number of branches running together. The plurality of AC panels is wired to a main service breaker with a surge protection device and a disconnect switch.

### FIELD OF THE INVENTION

The present invention relates generally to solar systems and more specifically to solar systems for a fuel station canopy with added safety features. The safety solar system for fuel station canopy comprises a solar system for converting solar radiation into electrical energy that has additional safety features to allow for installation on a fuel station canopy.

### BACKGROUND OF THE INVENTION

Solar energy is a needed addition to the mix of energy production that people use for their standard of living. Photovoltaic (PV) cells and their associated system convert solar radiation into electrical energy. PV cells are made of material when exposed to light, a voltage and electric current are generated. The voltage differential is caused when the light hits the PV cell material and generates an electron-hole pair which are swept in different directions by the electric field of the depletion region. Most modern systems use microinverters to convert the DC signal into AC signal to be compatible with modern electrical transmission systems. The microinverters can be connected to a single solar panel with a plurality of PV cells or can be configured to be connected to up to four solar panels. The output from multiple microinverters on large production systems are wired to combiner boxes. The combiner boxes can have a plurality of distribution blocks. The wiring running from the microinverters is commonly spliced into these boxes with wire nuts as the wire connectors. This is to reduce the wiring coming from a plurality of microinverters and combining them into fewer branches of wire thereby increasing efficiency by decreasing transmission losses. These are common fail points in the circuitry which can cause sparks and flash points and have devastating effects if located near flammable liquids and vapor such as in the garage of residential housing and fuel stations which have a constant presence of fuel vapors. The combiner boxes from multiple branches of microinverters are then wired to an ac panel that further reduces the plurality of wiring branches from the combiner boxes into fewer branches from the AC panels (ACPs) are then wired to the main service breaker. The ACPs are the first line of breakers to disconnect in case of a short circuit that could provide an ignition spark to the highly volatile vapor in the air. The main service breaker (MSB) provides a second line of breakers to be able to disconnect in case as the ACPs failure or a failure in the wiring between the ACPs and MSB. With the need to increase the renewable energy share of the total energy usage, private businesses are increasingly installing solar panels to contribute to the switch to renewable energy. This is complicated with fueling stations as the constant presence of flammable liquids and vapor necessitates increased safety measures to ensure the safety of the consumers and workers of fuel stations.

An objective of the present invention is to provide a system with increase safety measures to allow solar panels to be safely installed and function in a highly volatile environment that must inhibit unnecessary presence of arcing and ignition sparks of the flammable vapors.

An objective of the present invention is to provide a system to produce renewable energy in a safe and efficient manner. This is achieved by providing safety feature that allow combiner boxes and ACPs to be installed closer to the power generation thereby reducing the wiring and transmission losses by decreasing the distance between combining junction points.

A further objective is to provide a means to enhance the fireproofing of the combiner boxes and junction boxes near fuel stations. The present invention has several improvements that inhibits arcing and potential for ignition of fuel vapors and liquids present in various locations but in particularly at fuel stations.

A further objective is to provide weatherproofing of the ACPs to allow closer installation to the solar panels thereby increasing efficiency and transmission losses.

A further objective is to provide a system for solar energy production on fuel stations with greater safety measures that provide means for greater efficiency. The efficiency of the systems is increased due to the safety features and the ability to combine branches of wire sooner in the circuitry then allowable in the prior art.

### SUMMARY OF THE INVENTION

The safety solar system for fuel station canopies is a series of redundant safety features as well as waterproofing of certain components that allow the electrical junction points to be closer to the solar panels. The safety features of the present invention increase the efficiency and decreases the hazards for arcing that could cause an unwanted ignition spark. The decrease in distance possible from the added safety features and weatherproofing allows a decrease in response time for the circuit breakers to trip if a failure has been detected. The ignition spark could ignite the highly volatile fluids that are constantly present at a fueling station presenting a highly unsafe environment for all present. The present invention provides solar panels for energy production with a plurality of panels wired to a microinverter. A branch of microinverters is then wired to a combiner box to reduce the number of branches running together. A plurality of combiner boxes is wired to an ACP to provide a first line of breakers and again to reduce the number of branches from the combiner boxes running together. A plurality of ACPs is wired to a main service breaker with a surge protection device. This is then wired to a main disconnect switch which in turn is wired to the existing main distribution panel and which is connected to the utility grid.

### BRIEF DESCRIPTION OF THE DRAWINGS

FIG. 1A is a schematic view of the present invention.

FIG. 1B is a continuation of a schematic view of the present invention.

FIG. 2A is a schematic view of the portion of the solar system on the fuel station canopy.

FIG. 2B is a schematic view of the AC distribution panel area of the safety solar system on the fuel station canopy.

FIG. 3 is an illustration of the combiner box with the box floor lines with fire-retardant clay.

FIG. 4 is an illustration of the distribution blocks covered with fire-retardant clay.

FIG. 5 is an illustration of the ACP and panelboard on the fuel station canopy.

### DETAIL DESCRIPTIONS OF THE INVENTION

All illustrations of the drawings are for the purpose of describing selected versions of the present invention and are not intended to limit the scope of the present invention.

The specification includes references to “other embodiments” which do not necessarily refer to the same embodiment.

“First”, “second” etc. as contained herein are terms used as labels for nouns that they precede and do not imply ordering.

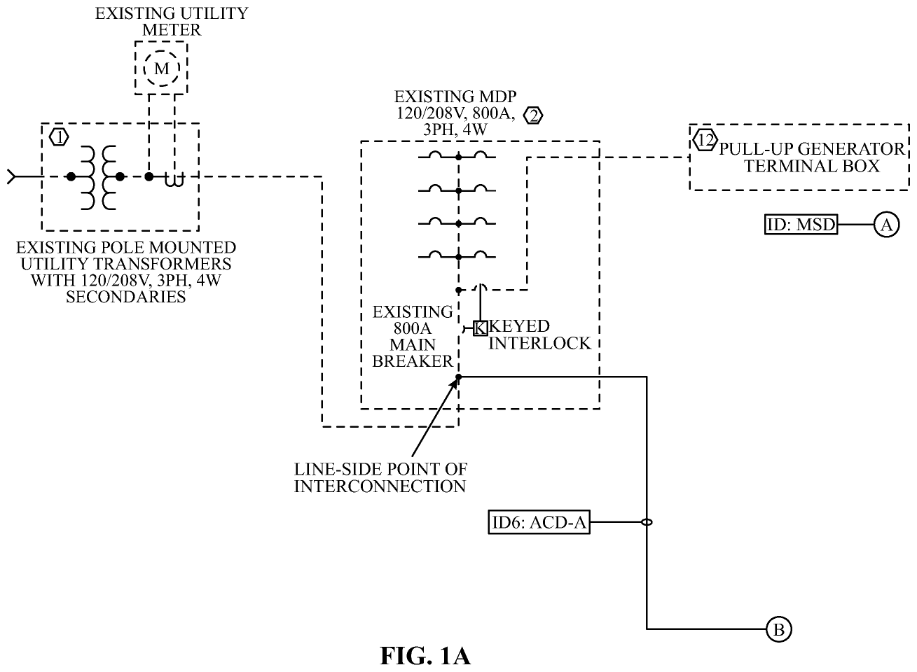

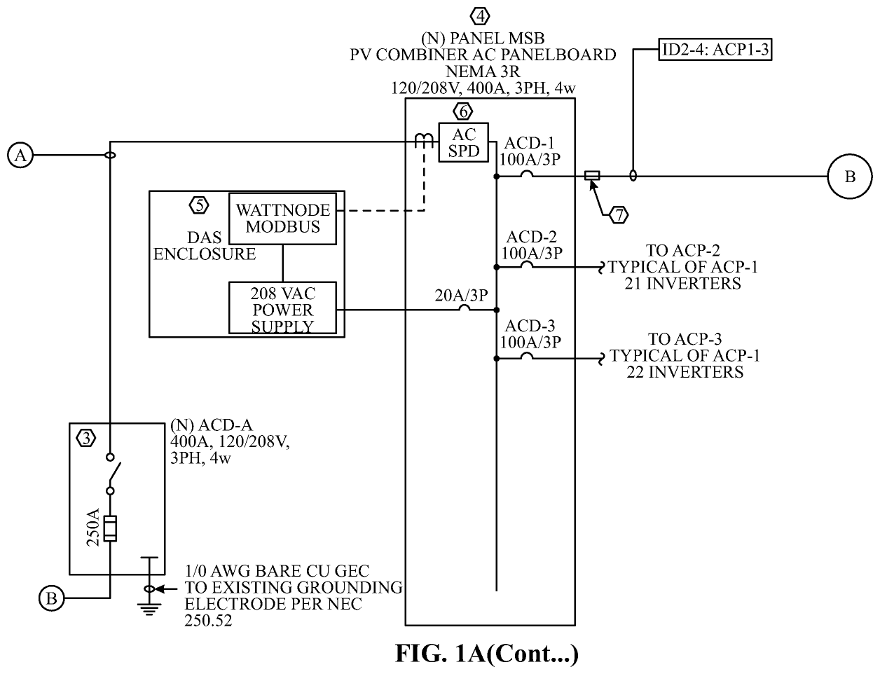

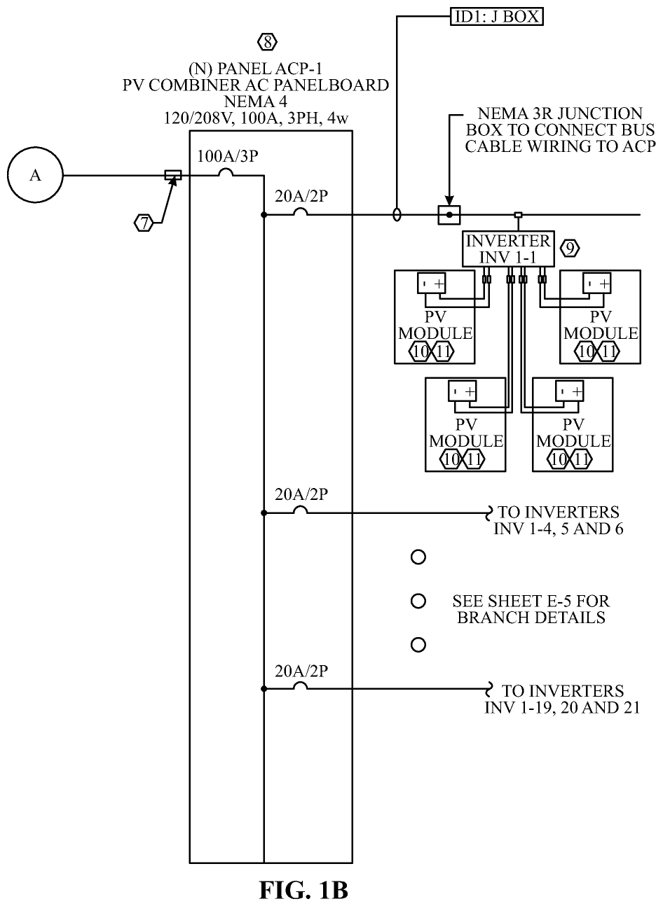

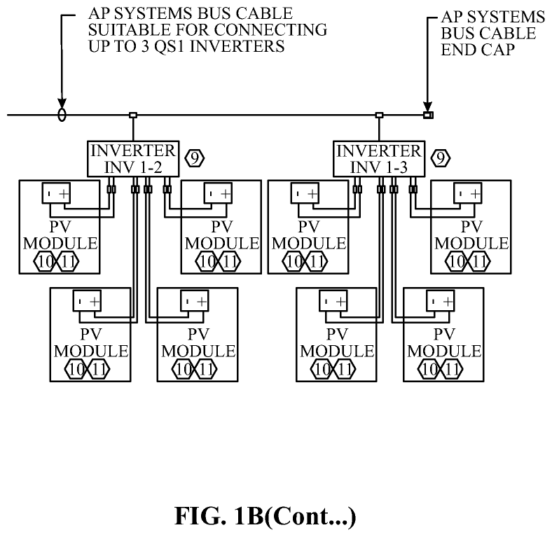

Referring now to the drawings, FIGS. 1A and 1B present a schematic of a first preferred embodiment of the safety solar system for fuel canopy. The present invention comprises a plurality of solar panels, a plurality of microinverters, a plurality of combiner boxes, a plurality of AC panel (ACPs), at least one main service breaker panel (MSB), a meter for monitoring revenue, at least one main disconnect switch. The dashed line represents existing components that the present invention connects and is not to represent any component of the present invention.

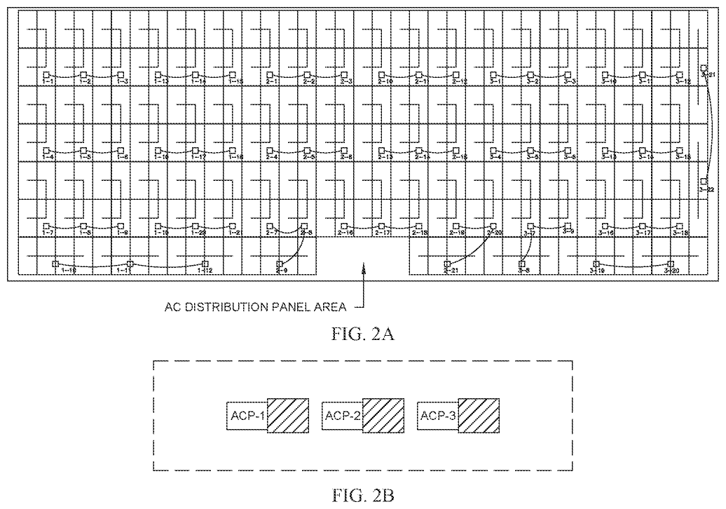

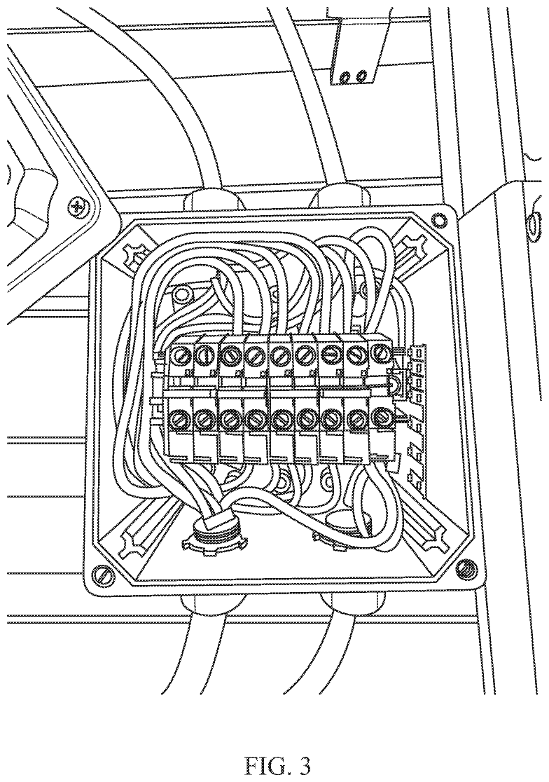

The first preferred embodiment is best suited for installation on a fuel station canopy but is not limited to this location or application. A fuel station canopy is typical covering for at least one automotive fuel station pump. FIG. 2A is a schematic showing a possible installation and wiring configuration for a portions of the solar system to be installed on the roof of the fuel station canopy comprising the plurality of solar panels, the plurality of microinverters, the plurality of combiner boxes, a racking system, and an AC distribution panel area to be installed on a fuel station canopy. The solar panels can be any market available solar panel such as Znshinesolar ZXM6-NH144. FIG. 2B shows a blown-up schematic of the layout for the AC distribution panel area with the crosshatch area representing workspace area and is not particular to the present invention. The plurality of solar panels is installed using the racking system suitable for solar panels.

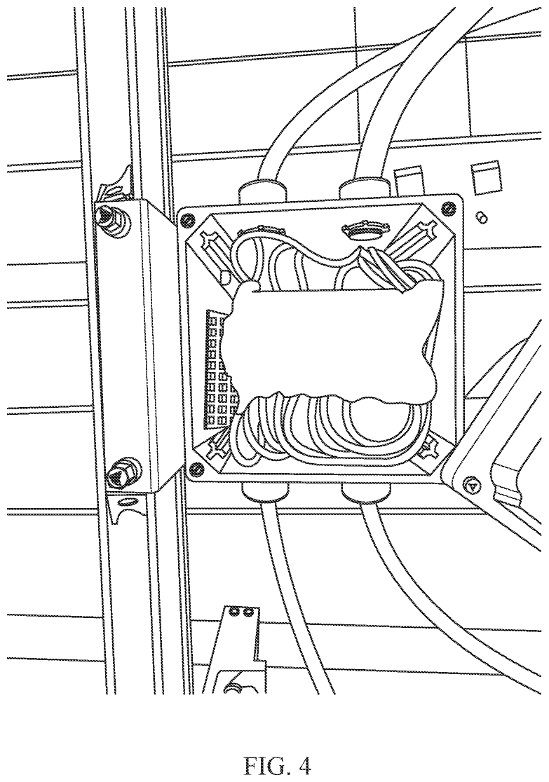

The racking system comprises a plurality of rails attached to the roof of the canopy having a plurality of brackets and fasteners capable of supporting the rails such as L-brackets and the solar panel is attached to the rails using a plurality of approved racking grounding lugs. The racking ground lugs can be any market available grounding lugs suitable for the solar panel such as ILSCO GBL-4DBT ground lug. The rails can be any market available rails such as c-channel and known to those skilled in the art. The solar panels receive sunlight and convert the light to a DC electrical energy. The solar panel is wired by a suitable cable such as 6 AWG and capable of at least 1650 Volt-amperes (V-A) of electrical power and is connected to the microinverters which convert the DC electrical energy to an AC electrical energy. There are 1-1 basis, 2-1 basis and 4-1 basis microinverters for combining 1, 2 or 4 solar panel configurations into a single microinverter based on the size and need of the project. In the first preferred embodiment, a 4-1 basis microinverter is used and can be any market available 4-1 microinverter such as QS1 from Altenergy Power systems. The 4-1 microinverter receives input from four solar panels as seen in FIG. 2A and outputs AC electrical energy. The 4-1 microinverter input has been converted to AC electrical energy output. The plurality of microinverters are wired to the combiner box. In the first preferred embodiment, the combiner box is an electrical box such as Integra Enclosures PV transition box comprising, a box, and a lid. As shown in FIG. 3, the box comprises a box floor having an inner box surface and a plurality of attachment holes, four lateral box sides, a plurality of distribution blocks and an attachment bracket fastened to the box floor, a plurality of lid fasteners and fastening holes, and fire-retardant clay. The box and lid define an inner box cavity. The fire-retardant clay lines the inner box surface of the box floor. Within the inner box cavity, the distribution blocks are attached to the attachment bracket which is then attached to the floor panel using the attachment holes. A layer of fire-retardant clay is used to cover the distribution blocks as shown in FIG. 4. The distribution blocks allow a safer wiring port than using wire nuts or similar securements as is typically done at wiring junctions. The wire nuts can come loose which leads to arcing and is a common cause of fires in solar systems. The fire-retardant clay is another layer of fireproofing in case there is ever a possible arc from possible overloading of the distribution block. The combiner box is wired to the ACPs by suitable wire cable such as 6 AWG capable of at least 1650 V-A of electrical power.

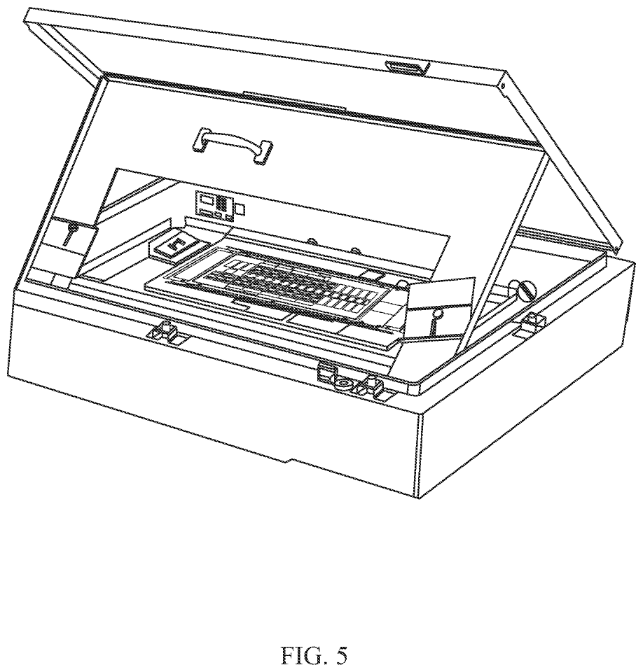

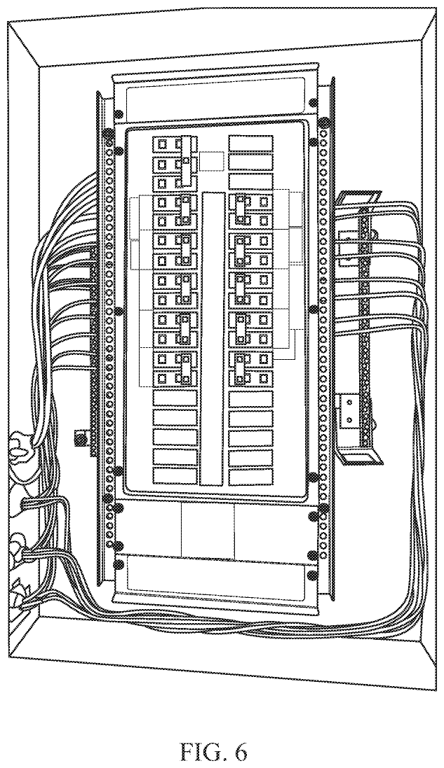

In the first preferred embodiment as shown in FIG. 2B, the AC distribution panel area comprises three ACPs but can be configured differently in other embodiments. As shown in FIG. 5 and FIG. 6, the ACP comprises a panel box, a lid having a lid brace, a circuit breaker panel having a plurality of panel breakers and at least one main panel breaker, a plurality of lid securing brackets, and a plurality of cable holes. The panel box having an ac panel floor, an open ac panel top having a top panel edge, four lateral ac panel walls, a raised lip around the top panel edge, and a plurality of fastener holes for attaching the circuit breaker panels with a plurality of breaker panel fasteners. The lid comprises a top panel, a lid lip to interlock with the raised lip, and a plurality of lid locking tabs to receive the lid securing brackets. The panel box and the ac panel lid define an ac panel inner cavity. The interlocking lips of the lid and the box weatherproof the ACP by keeping water out of the inner cavity of the ACP. This allows the ACP which is typically installed at a 90 degree to the floor or ground. The ACP can be installed at a 10 degree tilt from horizontal which is a typical tilt for the typical fuel station canopy roof. The ability to install the ACP decreases the delay time in disconnected the circuit when an failure occurs. It also increases the efficiency of the system by decreasing the distance between the combining boxes and the ACP. This decreases the transmission losses with redundant wiring running together for longer distances. The lid brace comprises a pivotally attached section wall having an open position and a closed position. The wall section comprises the section wall having a breaker panel cavity to allow access to the circuit break panel if the section wall is in the closed position. The brace facilitates work and maintenance on the circuit breaker panel by propping the lid open in the brace open position. The panel breakers are at least rated at 20 A and two pole. The main panel breaker has a rating of at least 100 A and three pole. Within the inner ac panel cavity, the circuit breaker panel is attached by means of fastening using the fastening holes on the panel floor. Each ACP is capable of supporting up to 3 combiner boxes which in turn each combiner box supports at least 12 microinverters in the current configuration but could be configured for more branches. The cable holes having cable hole edges allow the input cables from the combiner boxes and the output cables running to the main service breaker panel as described below. Between the cable hole edges and an outer surface of the various cables are gaps. These gaps can potentially allow fuel vapor inside the panel as well as allow fire to travel along the cable further compromising the system. These gaps are filled with fire-retardant clay. The plurality of the ACPs are wired to the main service breaker panel by suitable wire such as 3 AWG wire cable that is capable of supporting the ACPs input electrical power. The cable extension between each ACP and the main service breaker has a sealed fitting on either end of the cable extension near the output cable of the ACP and the input cables of the main service breaker. The sealed fitting comprises any market available sealed fitting such as EYSC expanded fill sealing fittings. The sealed fitting prohibits fuel vapor from flowing within the cable wiring.

The main service breaker box comprises a main circuit breaker panel having a plurality of main circuit breakers, and a main box with a door panel. The main box is a market available circuit breaker box suitable for supporting the main circuit breaker panel. The main circuit breakers each have a rating of at least 100 A and 3 pole for each ACP configured in the system. The main service breaker panel is equipped with a surge protection device. the surge protection device can be any market available surge protection device such as Eaton's SPD Series. A meter is also spliced into the main service breaker with a power supply sufficient to support the meter. In the first preferred embodiment, a Wattnode wide-range Modbus meter is used. The main service breaker is wired to a main disconnect switch. The main disconnect switch comprises a single throw switch. It could be any market available disconnect switch that can support 240 AC voltage.

Although the invention has been explained in relation to its preferred embodiment, it is to be understood that many other possible modifications and variations can be made without departing from the spirit and scope of the invention.

What is claimed is:

1. A safety solar system for fuel canopy, comprising,
A plurality of solar panels;
a plurality of microinverters;
a plurality of combiner boxes;
a plurality of AC panels;
at least one main service breaker panel;
a meter for monitoring revenue; and
at least one main disconnect switch.

2. A racking system for installing solar panels, comprising,
A plurality of rails attached to the roof of the canopy, said rails further comprising a plurality of brackets and fasteners capable of supporting the rails; and
A plurality of approved racking grounding lugs to attach the solar panel to the rails.

3. The solar panels of claim 1, said solar panels being wired to a suitable cable such as 6 AWG and capable of at least 1650 Volt-amperes (V-A) of electrical power; said solar panels further being connected to the microinverters of claim 1 to convert the DC electrical energy to AC electrical energy.

4. The microinverters of claim 1, said microinverters comprising 1-1 basis, 2-1 basis, and 4-1 basis for combining 1, 2 or 4 solar panel configurations into a single microinverter based on the size and need of the project.

5. The combiner boxes of claim 1, wherein the microinverters of claim 1 are connected to the combiner boxes, said combiner boxes further comprising:
A box, further comprising:
A box floor having an inner box surface and a plurality of attachment holes;
Four lateral box sides;
A plurality of distribution blocks and an attachment bracket fastened to the box floor, said distribution blocks allowing a safer wiring port than using wire nuts or similar securements;
A plurality of lid fasteners and fastening holes; and
Fire-retardant clay, said clay used to cover the distribution blocks and provide fireproofing in case of an arc from overloading of the distribution block; and
A lid.

6. The AC panels of claim 1, said panels further comprising:
A panel box, said panel box having an ac panel floor, an open ac panel top having a top panel edge, four later ac panel walls, a raised lip around the top panel edge, and a plurality of fastener holes for attaching the circuit breaker panels with a plurality of circuit breaker panel fasteners;
A lid having a lid brace, further comprising a top panel, a lid lip to interlock with the raised lip, and a plurality of lid locking tabs to receive the lid securing brackets, said lid brace further comprising a pivotally attached section wall having an open and a closed position;
A circuit breaker panel having a plurality of panel breakers and at least one main panel breaker;
A plurality of lid securing brackets; and
A plurality of cable holes, said cable holes having edges allowing the input cables from the container boxes and the output cables running to the main service breaker panel, said cable holes having gaps between the edges and the cables that are filled with fire-retardant clay.

7. The AC panels of claim 1, wired to the main service breaker panel by suitable wire that is capable of supporting the panels' input electrical power, said panels having a cable extension with a sealed fitting on either end near the output cable of the panel and the input cable of the main service breaker.

8. The at least one main service breaker panel of claim 1, comprising:
a plurality of main circuit breakers, said main circuit breakers each having a rating of at least 100 A and 3 pole for each AC panel in the system;
a main box with a door panel;
a surge protection device;
a meter spliced into the main service breaker with a power supply sufficient to support the meter; and
a main disconnect switch, said switch wired to the main service breaker and comprising a single throw switch that can support 240 AC voltage.
